(19) United States
(12) Patent Application Publication
(10) Pub. No.: US 2025/0028842 A1
(43) Pub. Date: Jan. 23, 2025

(54) CRYPTOGRAPHIC AGILITY FOR DATA STORAGE

(71) Applicant: VMware LLC, Palo Alto, CA (US)

(72) Inventors: Daniel James BEVERIDGE, Valrico, FL (US); Sean HUNTLEY, Sydney (AU); David OTT, Chandler, AZ (US)

(21) Appl. No.: 18/356,739

(22) Filed: Jul. 21, 2023

(51) Int. Cl. G06F 21/60; G06F 21/62

(52) U.S. Cl. CPC G06F 21/602; G06F 21/6209

(57) ABSTRACT

The disclosure provides an approach for providing cryptographic agility for data storage. Embodiments include receiving, by a cryptographic provider component, a request to perform a cryptographic operation with respect to a storage operation for a data object, wherein the cryptographic provider component is associated with an interception point between a metadata layer of a storage system and an object storage layer of the storage system. Embodiments include determining, by the cryptographic provider component, one or more attributes related to the request based on information received from the metadata layer about the data object. Embodiments include selecting, by the cryptographic provider component, based on the one or more attributes related to the request, a cryptographic technique for handling the request from a set of possible cryptographic techniques. Embodiments include storing, at the object storage layer, an encrypted version of the data object based on the selected cryptographic technique.

### BACKGROUND

Cryptography generally involves techniques for protecting data from unauthorized access. For example, data stored in a computing system may be encrypted in order to protect the data from being accessed by unauthorized parties. For example, even if the encrypted data is obtained by an unauthorized party, if the unauthorized party cannot decrypt the encrypted data, then the unauthorized party cannot access the underlying data. There are many types of cryptographic algorithms, and these algorithms vary in many aspects such as key size, ciphertext size, memory requirements, computation requirements, amenability to hardware acceleration, failure handling, entropy requirements, and the like. Key size refers to the number of bits in a key used by a cryptographic algorithm. Key size affects the strength of a cryptographic technique and is a configuration parameter. Having more bits in a key size results in more computation, but a larger space of possible mappings from cleartext to ciphertext, which is a quality makes it harder for an adversary to guess a key having a larger number of bits.

Ciphertext size refers to the number of bits in the output from a cryptographic algorithm, which may be the same as the number of bits of the input or may include padding to produce a larger number of bits than the input. Memory requirements and computation requirements generally refer to the amount of memory and processing resources required to perform an algorithm. Amenability to hardware acceleration generally refers to whether an algorithm requires or can be improved through the use of a hardware accelerator. For example, a compute accelerator is an additional hardware or software processing component that processes data faster than a central processing unit (CPU) of the computer. Failure handling refers to the processes by which an algorithm accounts for failures, such as recovering keys that are lost or deactivated. Entropy requirements generally refer to the amount of randomness required by an algorithm, such as an extent to which randomly generated values are used as part of the algorithm (e.g., which generally improves security of the algorithm).

Some cryptographic algorithms may result in a higher level of security (e.g., having more bits of security, more layers of security, larger amounts of entropy, and/or the like) than others, and there may be trade-offs with respect to resource requirements such that higher-security algorithms may require larger amounts of storage, processing, and/or communication resources. Furthermore, new cryptographic algorithms and libraries are developed on an ongoing basis to meet changing security needs. Cryptographic libraries are collections of cryptographic algorithms that can be invoked, such as through calls to application programming interface (API) functions provided by the libraries, in order to perform various cryptographic functions (e.g., encryption of data). In some cases, weaknesses in particular algorithms may be discovered over time such as due to advances in computing technology (e.g., a particular algorithm may be susceptible to being compromised through the use of computing devices with more power than the computing devices that were in use at the time the algorithm was developed). For example, algorithms may become problematic and/or become less useful for a variety of reasons, such as due to algorithmic compromise (e.g., a weakness in the algorithm may be discovered and/or exploited), compute performance increases (e.g., the time required to “guess correctly” may be reduced), and/or the like. In some cases, new and/or updated algorithms may be developed to address these issues (e.g., by adding additional bits of security, additional layers of security, more complex forms of encryption, and/or the like).

The rise of quantum computing has raised the possibility of additional issues related to cryptography. For example, the high levels of computational power provided by quantum computing may enable nefarious actors to more easily access data secured with existing cryptographic algorithms, thereby gaining access to sensitive data that was previously believed to be secure.

The dynamic nature of computing technology and the variety of threats that exist to data security necessitate a continuous adapting of cryptography to meet these new circumstances and threats. Furthermore, laws and/or regulations may require certain types of cryptography to be utilized in certain contexts. Thus, compliance with such laws and/or regulations may further necessitate adopting of new and/or different types of cryptographic algorithms.

Conventional computer storage systems are generally designed to implement and/or utilize particular cryptographic algorithms. These algorithms may be customizable in certain respects, but there is generally no convenient mechanism for changing the cryptographic algorithms utilized by a computing storage system without modifying the base code of the computing applications involved, essentially requiring portions of the code to be rewritten, which is time consuming and difficult. Such code modifications are expensive and error-prone, particularly when done on a regular basis to address the ever-changing landscape of computing security.

For certain types of computing storage systems, such as file systems and blob storage systems, conventional cryptographic techniques generally involve uniformly encrypting all data stored in such systems using fixed cryptographic algorithms. These conventional techniques are rigid, non-extensible, non-adaptable, and may result in unnecessary utilization of computing resources to encrypt data with a level of encryption that is not needed or not appropriate for the type of data, and/or may result in poor security through the use of cryptographic techniques that are outdated, compromised, and/or otherwise not secure enough for the type of data being stored.

As such, there is a need for improved cryptography techniques for computing storage systems that allow for extensibility, flexibility, and cryptographic agility.

### BRIEF DESCRIPTION OF THE DRAWINGS

FIG. 1 is an illustration of example computing components related to cryptographic agility for data storage, according to embodiments of the present disclosure.

FIG. 2 is an illustration of an example related to cryptographic agility for data storage.

FIG. 3 is an illustration of another example related to cryptographic agility for data storage.

FIG. 4 is an illustration of tagging cryptographic techniques related to cryptographic agility for data storage.

FIG. 5 depicts example operations related to cryptographic agility for data storage according to embodiments of the present disclosure.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

The present disclosure relates to providing cryptographic agility for data storage. In particular, the present disclosure provides an approach for enabling cryptographic agility for computing storage systems such as file systems and blob storage systems via integration with a cryptographic agility system that enables dynamic configuration, extensibility, automated selection, and implementation of optimal cryptographic techniques for particular data objects such as files or blobs.

Cryptographic agility generally refers to techniques for dynamic selection and/or configuration of cryptographic algorithms. According to certain embodiments, logic related to selection and/or configuration of cryptographic algorithms is decoupled from the applications that utilize cryptographic functionality, and is implemented in one or more separate components. For example, a cryptographic agility system described herein may expose an application programming interface (API) providing generic cryptographic methods that can be invoked by one or more components associated with a computing storage system in order to provide dynamic and performant cryptographic functionality. For example, an interception point between a metadata layer and an object storage layer of a computing storage system may invoke an API exposed by a cryptographic agility system described herein in order to request dynamic selection of cryptographic techniques for use in encrypting objects to be stored at the object storage layer. The cryptographic agility system may select such encryption techniques based on policies and/or based on attributes related to the object that is to be stored, such as based on file or blob metadata and/or other contextual information.

Thus, rather than relying on fixed cryptographic functionality provided by a computing storage system, embodiments of the present disclosure involve dynamic cryptography that is provided by a separate cryptographic agility system. In certain embodiments, the cryptographic agility system dynamically determines which libraries, algorithms, configuration values, and/or the like to select based on factors such as the type of data being encrypted, the type of application requesting storage of the data, the computing environment(s) in which the data is to be stored, geographic locations associated with storage of the data, attributes of users associated with the storage operation, regulatory environments related to the encryption, network conditions, resource availability (e.g., on devices performing encryption and/or decryption, and/or storage availability), performance constraints, device capabilities, and/or the like.

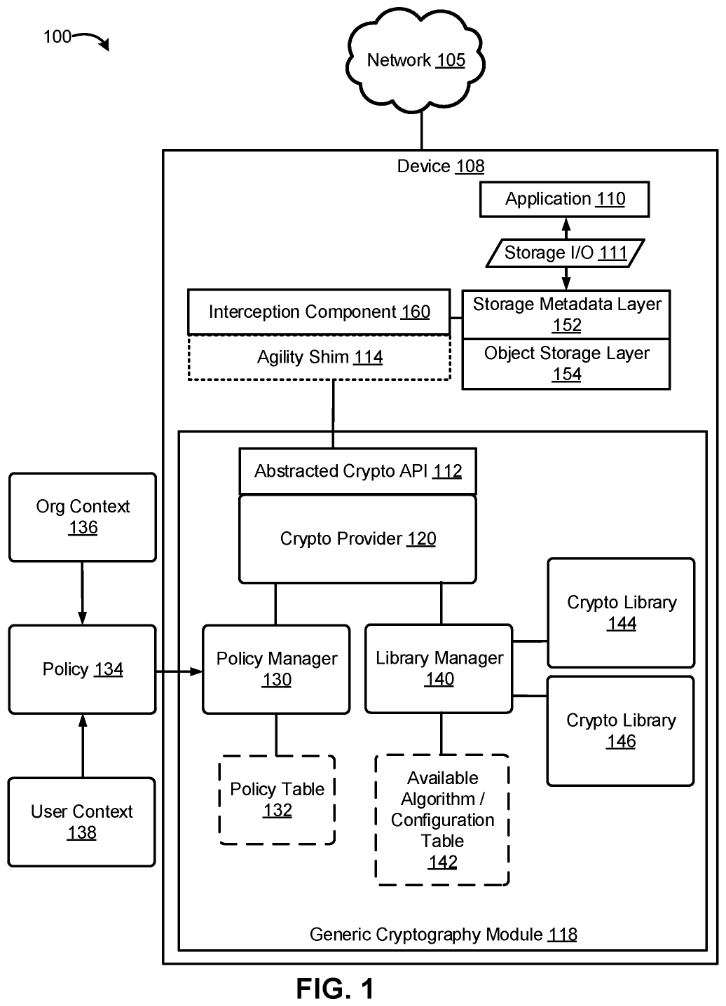

For example, policies may be defined by users (e.g., administrators), and may specify rules for selecting and/or configuring (e.g., setting particular parameters of) cryptographic algorithms. Policies may specify, for example, conditions under which cryptographic techniques must comply with one or more standards (e.g., Federal Information Processing Standards or FIPS), when a quantum-safe cryptographic technique must be selected, how to select among different quantum-safe cryptographic techniques, conditions for selecting key sizes (e.g., based on a desired level of security or based on different algorithm standards such as particular elliptical curves), and/or the like. In one example, cryptographic techniques (e.g., algorithms and/or configurations of algorithms) are tagged with different levels of security (e.g., rated from 0-10), and a policy associated with a computing storage system may specify that all data originating from a particular type of application or having one or more particular characteristics (e.g., having metadata indicating that the data is sensitive), is to be encrypted using a high-security algorithm (e.g., rated 8 or higher). Thus, if an application requests storage of data, and contextual information indicates that the application is of the particular type or that the data has one or more of the particular characteristics, in certain embodiments, the cryptographic agility system will select a cryptographic algorithm tagged as a high-security algorithm, such as with a security rating of 8 or higher. In certain cases, as described in more detail below with respect to FIGS. 1-3, the cryptographic agility system is associated with an interception point between a metadata layer of the storage system (e.g., that receives requests to store data) and an object storage layer of the storage system (e.g., where the data is actually stored), and dynamically selects cryptographic techniques for use in encrypting the data before it is stored. For instance, certain embodiments involve the use of a mini filter driver between a file system driver and a block driver of a file system to intercept write requests to the file system and interface with an out-of-process cryptographic agility system that dynamically selects cryptographic techniques for use in encrypting files to be stored in block storage of the file system. Similar arrangements may be implemented for other types of storage systems, such as blob storage systems. In another example, cryptographic techniques are tagged with indications of whether they comply with particular standards, and a policy may specify that all data associated with a particular application or for a particular purpose is to be encrypted with a cryptographic technique that complies with a particular standard (e.g., FIPS). In such an example, if an application calls a function provided by the cryptographic agility system to encrypt an item of data, and contextual information indicates that the data relates to the particular purpose or that the application is the particular application, then the cryptographic agility system, in certain embodiments, will select a cryptographic algorithm tagged as being compliant with the particular standard. Cryptographic techniques may be tagged with classifications (e.g., indicating security levels, threats protected against, and/or the like), which may take a variety of forms, such as high, medium, and low, numerical scales (e.g., 0-10), binary indications, and/or the like. In some embodiments, classifications may be imported from one or more sources, such as cryptographic technique providers, open source entities, standards bodies, and/or the like.

In yet another example, cryptographic techniques are tagged with indications of whether they have certain characteristics or support certain configurations, and a policy may specify that all data that is to be transmitted as part of a data aggregation process is to be encrypted using a cryptographic technique that does or does not have one or more particular characteristics or configurations. Thus, if the cryptographic agility system receives a request to encrypt an item of data for a data aggregation process, then the cryptographic agility system, in certain embodiments, will select a cryptographic algorithm tagged with indications that the cryptographic algorithm does or does not have the one or more particular characteristics or configurations indicated in the policy. Accordingly, an organization or user may specify policies based on their own preferences of which characteristics or configurations of cryptographic techniques are most secure or desirable and/or based on specific compliance requirements.

By decoupling cryptographic logic from a storage system in which encrypted data is stored, techniques described herein provide flexibility and extensibility, thus allowing cryptographic algorithms to be continually updated, changed, and otherwise configured without requiring modifications to the storage system or associated applications themselves. Accordingly, changing circumstances and new threats may be addressed in a dynamic and efficient manner, and computing security may thereby be improved.

In some embodiments, one or more cryptographic provider components of the cryptographic agility system include logic for analyzing information associated with a cryptographic request according to rules and/or policies in order to select among a library of available cryptographic techniques (e.g., that may be registered with the cryptographic agility system by an administrator). A cryptographic provider component may include a cryptographic router that selects between different cryptographic implementation components for performing selected cryptographic techniques. For example, as requests from one or more applications are received at the cryptographic provider, the cryptographic router may ensure that the requests are handled by appropriate modules that perform cryptographic techniques. In some embodiments, cryptographic implementation components are executable components that perform particular cryptographic functionality, such as encrypting or decrypting data using particular cryptographic algorithms. The cryptographic implementation components may be loaded as needed based on selection of cryptographic techniques for servicing particular requests. In some cases, more than one cryptographic implementation component that performs a given cryptographic technique may be loaded, and the cryptographic router may perform load balancing and/or prioritization functionality to assign requests to particular cryptographic implementation components.

In a cryptographic agility system, an initial stage of selecting a cryptographic technique may involve ensuring that the security requirements for a given cryptographic operation, such as a level of security required by policy and/or context information, are met. In some cases, there may be multiple algorithms and/or configurations of algorithms that meet these requirements. Resource-related considerations may also be factored into the determination of which algorithms and/or configurations to use, such as based on device performance metrics and/or capability information. In one example, the cryptographic agility system selects a cryptographic technique with a highest security rating of those that comply with all relevant policies and/or resource constraints related to a particular storage request.

Thus, the cryptographic agility system may select algorithms and/or configurations of algorithms that are best suited to the context, resource availability, performance, and/or capabilities of the applications and/or devices associated with a request to perform a cryptographic operation with respect to storing data.

In some cases, cryptographic algorithms and/or configurations of algorithms may be dynamically switched over time for data that has already been encrypted and stored, such as based on changing circumstances. For example, if a policy changes such that a given item of stored encrypted data no longer complies with the policy, the cryptographic agility system may select a new cryptographic technique for the given item of data that is policy-compliant, and may decrypt and re-encrypt the item of data using the new cryptographic technique. In some embodiments, a component associated with the storage system occasionally (e.g., at certain intervals) performs a compliance check for data stored in the storage system to ensure that each item of stored data is encrypted with an optimal and/or policy-compliant cryptographic technique. As new cryptographic techniques become available and are registered with the cryptographic agility system, these newly added cryptographic techniques may in some cases be better suited to particular items of data that are stored in the storage system than the previously-used cryptographic techniques, and these items of data may in some cases be decrypted and re-encrypted using the newly added cryptographic techniques.

Embodiments of the present disclosure improve upon conventional cryptography techniques in which cryptographic algorithms are pre-determined for storage systems (e.g., at design time) by allowing cryptographic algorithms and/or configurations to be dynamically selected and changed over time based on contextual information, even if a storage system or associated application was not designed to support such functionality. For example, utilizing a cryptographic agility system to dynamically select cryptographic algorithms and/or configurations based on contextual and policy information, techniques described herein improve the security and functioning of devices on which cryptographic operations are performed, such as by, in certain embodiments, ensuring that the most secure and updated cryptographic techniques that are consistent with device constraints and other context information may be utilized, even if such techniques were not available at the time the storage system and/or associated applications were developed.

Additionally, techniques described herein may facilitate an organization's use of uniform policy configuration (e.g., a suite of coordinated policies), such as to orchestrate cryptographic usage across many hosts (e.g., for federated data centers deployed worldwide). Embodiments of the present disclosure may also be used to facilitate migration to new cryptographic algorithms at scale and/or to remove deprecated cryptographic algorithms from use in a centralized and coordinated manner.

Furthermore, by intercepting storage requests between a metadata layer of a storage system and an object storage layer of the storage system, such as via a mini filter driver or other interface component, and utilizing metadata associated with storage requests to dynamically select cryptographic techniques for encrypting data for storage, embodiments of the present disclosure integrate with existing storage systems and allow the benefits of cryptographic agility to be obtained without significant changes to the underlying storage systems or associated applications.

FIG. 1 is an illustration 100 of example computing components related to cryptographic agility for data storage, according to embodiments of the present disclosure.

A device 108 is connected to a network 105. In certain embodiments, device 108 may be a physical or virtual computing device, such as a server computer, that hosts an application 110 and stores data. In some embodiments, device 108 may be a virtual computing instance (VCI), such as a virtual machine (VM) or container that runs on a physical host computer. Network 105 may be any sort of network over which data may be transmitted, such as a local area network (LAN), cellular network, satellite-based network, the Internet, or the like. It is noted that device 108 is included as an example computing device on which application 110 and/or associated components may be located, and other types of devices may also be used.

Application 110 generally represents a software application that stores and/or retrieves data from a storage system that includes a storage metadata layer 152 and an object storage layer 154. While conventional techniques for encrypted data storage generally involve direct integration of one or more fixed cryptographic techniques with a storage system, techniques described herein involve abstracting cryptographic functionality away from a storage system. As such, an abstracted crypto application programming interface (API) 112 is provided as a means of facilitating cooperation between a storage system and a separate cryptographic agility system, such as via an interception component 160. For instance, interception component 160 may intercept storage write requests directed to storage metadata layer 152 and may make calls to abstracted crypto API 112, in order to invoke cryptographic functionality provided by a cryptographic agility system as described herein.

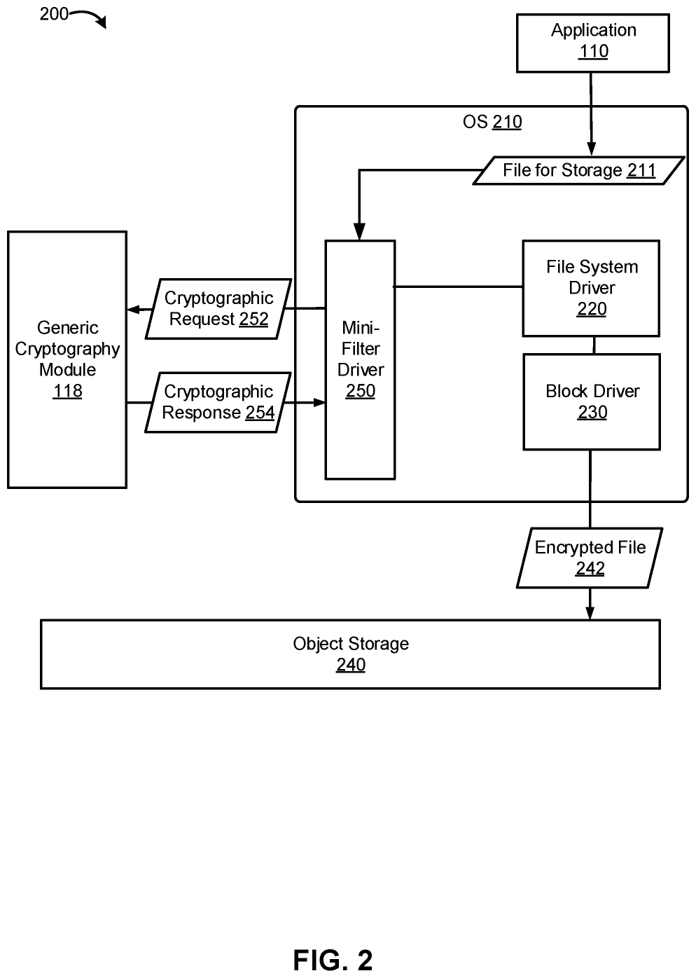

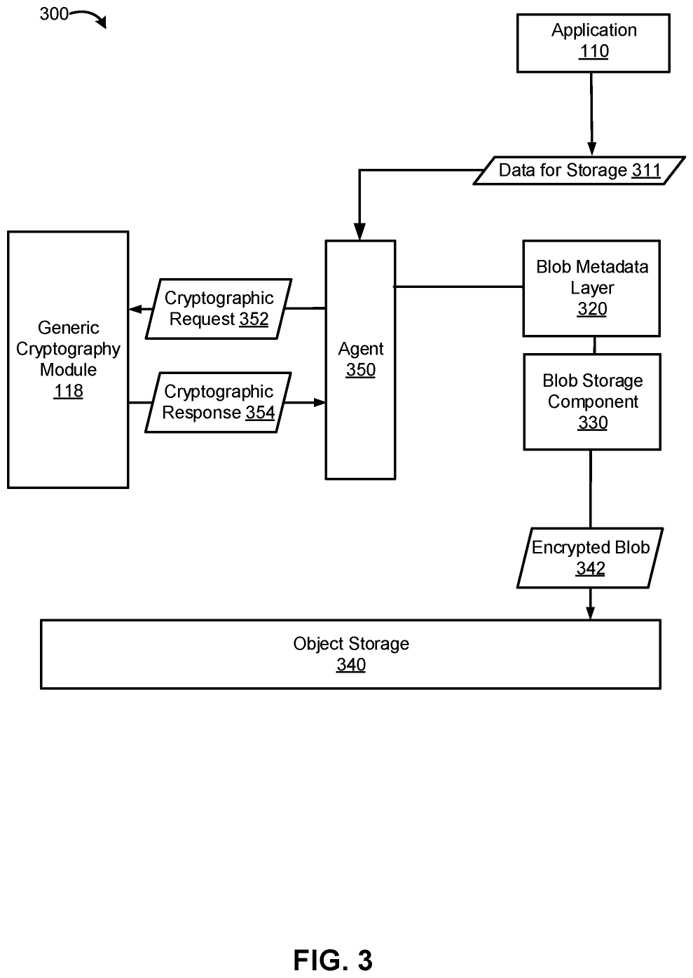

In an example, application 110 issues a storage I/O request 111, such as a request to write a data item (e.g., file or blob) to a storage system (e.g., a file system or blob storage system). While the storage I/O request 111 is directed to storage metadata layer 152, it is intercepted by interception component 160. For example, as described in more detail below with respect to FIGS. 2 and 3, interception component 160 may be a mini-filter driver (e.g., associated with a file system driver) or other type of agent (e.g., associated with a blob storage system). Interception component 160 then sends a request to crypto provider 120, via a call to abstracted crypto API 112, to dynamically select a cryptographic technique for encrypting the data item before it is stored.

The cryptographic agility system includes abstracted crypto API 112 and, in certain embodiments, an optional agility shim 114, as well as crypto provider 120, policy manager 130, and library manager 140. In some embodiments, while depicted as separate components, agility shim 114, abstracted crypto API 112, policy manager 130, and/or library manager 140 may be part of crypto provider 120.

Agility shim 114 generally intercepts API calls (e.g., calls to functions of abstracted crypto API 112) and redirects them to crypto provider 120 via abstracted crypto API 112. Shims generally allow new software components to be integrated with existing software components by intercepting, modifying, and/or redirecting communications. As such, agility shim 114 allows interception component 160, storage metadata layer 152, or another component to interact with crypto provider 120 even though such a component itself may have no knowledge of crypto provider 120. For instance, interception component 160 may make generic cryptographic function calls (e.g., requesting that an item of data be encrypted), and these generic function calls may be intercepted by agility shim 114 (e.g., if such a shim is needed) and redirected to crypto provider 120 via the abstracted crypto API 112 exposed by crypto provider 120.

It is noted that while embodiments of the present disclosure are depicted on device 108, alternative embodiments may involve various components being located on more or fewer computing devices. In some cases, aspects of the cryptographic agility system may be implemented in a distributed fashion across a plurality of computing devices. In certain embodiments, said components may be located on a single computing device.

In certain embodiments, generic cryptography module 118 comprises a physical or virtual computing device, such as a server computer, on which components of the cryptographic agility system, such as crypto provider 120, policy manager 130, and/or library manager 140, reside. For example, generic cryptography module 118 may represent a VCI or a physical computing device. Generic cryptography module 118 may be connected to network 105 and/or one or more additional networks.

Crypto provider 120 generally performs operations related to dynamically selecting cryptographic techniques (e.g., based on contextual information related to requests for cryptographic operations), performing the requested cryptographic operations according to the selected techniques, and providing results of the operations to the requesting components or to other recipient components. Cryptographic techniques may include cryptographic algorithms (e.g., included in one or more libraries) and/or specific configurations of cryptographic algorithms, as described herein. According to certain embodiments, policies are defined by an enterprise administrative team deploying a storage system, rather than being defined by a storage system user. Accordingly, policies may be used to determine (e.g., on behalf of users) which cryptographic techniques to use (e.g., based on organizational policies). Policy-based selection of cryptographic techniques may be based on contextual information related to a cryptographic request.

In certain aspects, crypto provider 120 has two major subsystems, policy manager 130 and library manager 140. Policy manager 130 performs operations related to cryptographic policies, such as receiving policies defined by users and storing information related to the policies in a policy table 132. According to certain embodiments, a centralized policy control server may orchestrate policy across a plurality of generic cryptography modules, such as including generic cryptography module 118. For example, an administrator or other user may configure one or more policies at a centralized policy control server, and the one or more policies may be distributed to a plurality of generic cryptography modules for storage by corresponding policy managers, such as including policy manager 130. In an example, a policy 134 is based on one or more of an organizational context 136 and a user context 138 related to a cryptographic request. In some embodiments, a policy may map a cryptographic request and its associated context information to attributes of cryptographic techniques, such as a particular cryptographic technique in a particular cryptographic library and a particular set of parameters for configuring the particular cryptographic technique.

Organizational context 136 may involve geographic region (e.g., country, state, city and/or other region), industry mandates (e.g., security requirements of a particular industry, such as related to storage and transmission of medical records), government mandates (e.g., laws and regulations imposed by governmental entities, such as including security requirements), and the like. For instance, policy 134 may indicate that if a cryptographic request is received in relation to a device (e.g., client device or other device, such as device 108) associated with a particular geographic region, associated with a particular industry, and/or within the jurisdiction of a particular governmental entity, then crypto provider 120 must select a cryptographic technique that meets one or more conditions (e.g., having a particular security rating and/or being configured to protect against particular types of threats) in order to comply with relevant laws, regulations, or mandates.

User context 138 may involve user identity (e.g., a user identifier or category, which may be associated with particular privileges), data characteristics (e.g., whether the data is sensitive, classified, or the like), application characteristics (e.g., whether the application is a business application, an entertainment application, or the like), platform characteristics (e.g., details of an operating system), device characteristics (e.g., hardware configurations and capabilities of the device, resource availability information, and the like), device location (e.g., geographic location information, such as based on a satellite positioning system associated with the device), networking environment (e.g., a type of network to which the device is connected, such as a satellite or land-based network connection), and/or the like. In some cases, aspects of user context 138 may be determined from metadata associated with an object such as a file that is to be stored, such as from a header of the file. In some embodiments, aspects of user context may include a size of a data object, a file extension of a data object, an application or user associated with creation or modification of a data object, a name of a data object, contents of a data object, and/or the like.

For example, policy 134 may indicate that if a cryptographic request is received in relation to a particular category of user (e.g., administrators, general users, or the like), relating to a particular type of data (e.g., tagged as sensitive or meeting characteristics associated with sensitivity, such as being financial or medical data), associated with a particular application or type of application, associated with a particular platform (e.g., operating system), associated with a device with particular capabilities or other attributes (e.g., a device having a certain amount of processing or memory resources, or having an accelerator), and/or in relation to a device in a particular location (e.g., geographic location), then crypto provider 120 should select a cryptographic technique that meets one or more conditions. In certain embodiments, a policy may simply specify an allowed list of ciphers or an allowed list of cryptographic technique characteristics. In some cases, a policy 134 may relate to resource constraints (e.g., based on available processing, memory, or network resources), such as specifying that cryptographic techniques must be selected based on resource availability (e.g., how much of a device's processing and/or memory resources are currently utilized, and the like) and/or capabilities (e.g., whether a device is associated with an accelerator) associated with devices, while in other embodiments crypto provider 120 selects cryptographic techniques based on resource constraints independently of policy manager 130 (e.g., for all cryptographic requests regardless of whether any policies are in place). For example, policies may only relate to security levels of cryptographic techniques, such as requiring the use of cryptographic techniques associated with particular security ratings when certain characteristics are indicated in contextual information related to a cryptographic request, and resource constraints may be considered separately from policies. Policies may also relate to privacy-preservation, such as requiring homomorphic encryption or confidential computing, or specific types of homomorphic encryption or confidential computing, under certain circumstances. In one example, once all cryptographic techniques meeting the security requirements for a cryptographic request are identified based on policies, a cryptographic technique is selected from these policy-compliant cryptographic techniques based on resource constraints.

Policy table 132 stores information related to policies, such as policy 134. In some embodiments, policy table 132 maps various contextual conditions (e.g., relating to organizational context and/or user context) to cryptographic technique characteristics (e.g., whether techniques have certain security ratings, protect against certain threats, have certain resource utilization ratings, and the like). For example, a contextual condition may be the use of a certain type of application, a certain type of data, or a particular geographic location. A cryptographic technique characteristic may be, for example, a security rating (e.g., 0-10), whether the cryptographic technique is quantum-safe, what level of resource requirements the cryptographic technique has for a particular type of resource (e.g., memory, processor, or network resources), or the like. Thus, when cryptographic requests are received, policy table 132 may be used to determine whether the cryptographic requests are associated with any characteristics included in policies and, if so, what cryptographic technique characteristics are required by the policies for servicing the requests.

Library manager 140 generally manages cryptographic libraries containing cryptographic algorithms. For example crypto libraries 244 and 246 each include various cryptographic algorithms and/or techniques, each of which may include configurable parameters, such as key size, choice of elliptic curve, algorithm sizing parameters, and the like, and characteristics such as ciphertext size. For instance, cryptographic techniques (e.g., algorithms and/or specific configurations of algorithms, and/or confidential computing techniques) may be registered with library manager 240 along with information indicating characteristics of the cryptographic techniques. Examples of algorithms include data encryption standard (DES), triple DES, advanced encryption standard (AES), the Paillier cryptosystem, the Boneh-Goh-Nissim cryptosystem, the Rivest-Shamir-Adleman (RSA) cryptosystem, the Gentry cryptosystem(s), the Brakerski-Gentry-Vaikuntanathan (BGV) cryptosystem(s), the Cheon, Kim, Kim and Song (CKKS) cyrptosystem(s), the Clear and McGoldrick multi-key homomorphic cryptosystem, Diffie-Hellman (DH) encryption, Elliptic Curve DH (ECDH) encryption, digital signatures such as Digital Signature Algorithm (DSA) and Elliptic Curve DSA (ECDSA), cryptographic hash functions such as Secure Hash Algorithm 2 or 3 (SHA-2 or SHA-3), and others. There are many other types of encryption algorithms, and the algorithms listed herein are included as examples. Some algorithms may, for example, involve symmetric key encryption or asymmetric key encryption, digital signatures or cryptographic hash functions, and/or the like. A configuration of an algorithm may include values for one or more configurable parameters of the algorithm, such as key size, size of lattice, which elliptic curve is utilized, number of bits of security, whether accelerators are used, ciphertext size, and/or the like. A characteristic of a cryptographic technique may be, for example, a security rating, a resource requirement rating, whether the technique requires an accelerator, whether the technique is quantum-safe, or the like. A cryptographic technique may include more than one cryptographic algorithm and/or configuration. In an example, each cryptographic technique is tagged (e.g., by an administrator) based on characteristics of the technique, such as with a security rating, an indication of threats protected against by the technique, indications of the resource requirements of the technique, an indication of whether the technique is homomorphic, and/or the like.

Information related to cryptographic techniques registered with library manager 140 is stored in available algorithm/configuration table 142. For instance, available algorithm/configuration table 142 may store identifying information of each available cryptographic technique (e.g., an identifier of a library, an identifier of an algorithm in the library, and/or one or more configuration values for the algorithm) associated with tags indicating characteristics of the technique. It is noted that policies and tags are examples of how cryptographic techniques may be associated with indications of characteristics, and alternative implementations are possible. For instance, rather than associating individual cryptographic techniques with tags, alternative embodiments may involve associating higher-level types of cryptographic techniques with tags, and associating individual cryptographic techniques with indications of types. For example, a higher-level type of cryptographic technique may be “symmetric key encryption algorithms configured with a key size of 200 bits or larger.” Thus, if tags are associated with this type (e.g., including security ratings, recourse requirement ratings, and the like), any specific cryptographic techniques of this type (being symmetric key encryption algorithms, and being configured with a key size of 200 bits or more) will be considered to be associated with these tags. In another example, fuzzy logic and/or machine learning techniques may be employed, such as based on historical cryptographic data indicating which cryptographic techniques were utilized for cryptographic requests having particular characteristics. In some embodiments, tags may be associated with specific configurations of cryptographic algorithms, such as assigning a security rating to a particular set of configuration parameters for a particular cryptographic algorithm or type of algorithm.

Tags associated with cryptographic techniques may be updated as appropriate over time, such as based on input from a user (e.g., an administrator, security operations professional, and/or the like). For example, a user may provide input upgrading or downgrading a security rating for a particular cryptographic technique, type of cryptographic technique, or configuration of a cryptographic technique (e.g., from 10 out of 10 to 8 out of 10), such as based on changed understandings of vulnerabilities or strengths of particular techniques.

By allowing cryptographic techniques and libraries to be registered and deregistered with library manager 140 on an ongoing basis, and to be associated with metadata such as tags that can be dynamically updated, embodiments of the present disclosure allow the pool of possible cryptographic techniques to be continuously updated to meet new conditions and threats. For example, as new libraries are developed, these libraries may be added to library manager 140, and the cryptographic techniques in the library may be used by crypto provider 120 in servicing requests associated with a storage system without the storage system or associated applications having any awareness of the new libraries. Similarly, by managing policies and libraries separately, policies may be defined in an abstract manner (e.g., based on characteristics of requests and cryptographic techniques) such that policies may be satisfied through the selection of new cryptographic techniques that were not known at the time of policy creation. In one particular example, a new cryptographic technique is tagged as quantum safe, meaning that the cryptographic technique was developed to be resistant to being decoded by quantum computers. For instance, the new cryptographic technique may have a high security rating (e.g., 10 out of 10) as well as high resource requirements. The new cryptographic technique is registered with library manager 140, and information about the new cryptographic technique and its characteristics is stored in available algorithm/configuration table 142. Thus, the new cryptographic algorithm is available to be selected by crypto provider 120 for servicing cryptographic requests from the proxy component related to application 110.

Continuing with the example, a policy 134 states that cryptographic requests relating to data that is long-lived (e.g., of a type that must be protected over a long amount of time, such as many years) is to be encrypted using a quantum-safe cryptographic technique if such a technique is available, unless device resource constraints prohibit the use of such a technique. Long-lived data may include, for example, classified government data, certain types of personally-identifiable information, and the like. Data that is not long-lived may include, for example, a code or password that expires after a short amount of time, a credit card number that is updated at regular intervals, network configuration data that changes on a regular basis, and the like. Whether or not data in a file is long-lived data may be determined in some cases based on metadata associated with the file. A policy 134 may also state that if a cryptographic request relates to long-lived data but resource constraints prohibit the use of a technique tagged as quantum-safe, then a combination of cryptographic techniques with resource requirements consistent with the resource constraints should be utilized, such as in a repeating pattern.

Thus, when interception component 160 submits a cryptographic request (e.g., via a call to a generic cryptographic function provided by abstracted crypto API 112) to encrypt an item of long-lived data for storage at object storage layer 154, crypto provider 120 determines based on information stored in policy table 132 that a quantum-safe cryptographic technique is to be used if possible, or otherwise to use a combination of cryptographic techniques. Crypto provider 120 determines based on information in available algorithm/configuration table 142 that the new cryptographic technique is quantum-safe. Next, crypto provider 120 analyzes resource constraints related to the cryptographic request to determine if the new cryptographic technique can be performed. If crypto provider 120 determines that device 108 can support the new cryptographic technique (e.g., based on available resources), then crypto provider 120 selects the new cryptographic technique for servicing the cryptographic request, and provides a response to interception component 160 (e.g., via agility shim 114) accordingly. Alternatively, if crypto provider 120 determines that device 108 cannot support the new cryptographic technique (e.g., based on available resources), then crypto provider 120 selects a plurality of cryptographic techniques consistent with the available resources of the device and/or network for servicing the cryptographic request according to a pattern, and provides a response to interception component 160 (e.g., via agility shim 114) accordingly. In some cases, the response sent from crypto provider 120 to interception component 160 includes data encrypted using the selected technique(s). In other cases, the response includes information related to performing the selected technique(s) to encrypt the data, and the encryption is performed by the entity from which the request was sent or by another entity.

In some cases, more than one cryptographic technique may be selected for servicing a given cryptographic request together, without utilizing a pattern. For instance, an item of data may first be encrypted using a first technique (e.g., that satisfies one or more first conditions related to policy and/or resource considerations) and then the encrypted data may be encrypted again using a second technique (e.g., that satisfies one or more second conditions related to policy and/or resource considerations).

Data encrypted using techniques dynamically selected by crypto provider 120 as described herein may then be stored at object storage layer 154. When such data is retrieved from object storage layer 154, such as via a read request sent by application 110 (e.g., another example of storage I/O 111), the encrypted data is retrieved and decrypted (e.g., by crypto provider 120) using the one or more cryptographic techniques that were used to encrypt the data prior to storage.

FIG. 2 is an illustration 200 of an example related to cryptographic agility for data storage. Illustration 200 includes application 110 and generic cryptography module 118 of FIG. 1. In particular, illustration 200 depicts an embodiment involving a file system.

Application 110 sends a file 211 for storage (e.g., via a write request) to an operating system (OS) 210, such as by sending a request to a file system comprising a file system driver 220 of OS 210.

A file system generally refers to a system and/or data structure(s) that an OS uses to control how data is stored and retrieved. File system driver 220 may be an example component of a storage metadata layer 152 of FIG. 1. Block driver 230 and/or object storage 240 may be example components of an object storage later 154 of FIG. 1.

Mini-filter driver 250 intercepts the write request, receiving file 211. Mini-filter driver 150 may be an example of interception component 160 of FIG. 1. A file system filter driver generally intercepts requests targeted at a file system or another file system filter driver. By intercepting the request before it reaches its intended target, the filter driver can augment or replace functionality provided by the original target of the request. A filter driver that is developed to the “filter manager” model is called a mini-filter driver. The filter manager is a kernel-mode driver that conforms to legacy file system filter models and implements and exposes functionality that is commonly required in file system filter drivers. Developers can create mini-filter drivers using this exposed functionality, making such drivers simpler to develop than legacy file system filter drivers.

Mini-filter driver 250 sends a cryptographic request 252 to generic cryptography module 118, such as via an API as discussed above with respect to FIG. 1. Cryptographic request 252 may comprise a request to encrypt file 211 for storage. Generic cryptography module 118 receives cryptographic request 252 and dynamically selects one or more cryptographic techniques for handling cryptographic request 252, such as for encrypting file 211. As discussed above with respect to FIG. 1, generic cryptography module 118 may determine attributes related to file 211, such as based on metadata associated with file 211, and select a cryptographic technique based on such attributes, such as according to one or more policies. The attributes may include, in some embodiments, organizational context and/or user context. For example, the attributes may include or be based on a size of file 211, a file extension of file 211, an application or user associated with creation or modification of file 211, a name of file 211, contents of file 211, and/or the like.

Generic cryptography module 118 provides cryptographic response 254 to mini-filter driver 250 in response to cryptographic request 252. Cryptographic response 254 may, for example, comprise an encrypted version of file 211 according to one or more selected cryptographic techniques. For instance, generic cryptography module 118 may encrypt file 211 using a dynamically selected technique and then provide the encrypted file to mini-filter driver 250. In other embodiments, cryptographic response 254 includes information that can be used by one or more other components to encrypt file 211, such as an indication of a cryptographic technique, an encryption key, and/or the like.

If cryptographic response 254 comprises an encrypted version of file 211, then mini-filter driver 250 may provide the encrypted file to file system driver 220, which may then provide the encrypted file to block driver 230 for writing to object storage 240. For example, block driver 230 writes encrypted file 242 to object storage 240. If cryptographic response 254 includes information for use in encrypting file 211, then file 211 may be encrypted by some other component (e.g., associated with mini-filter driver 250, file system driver 220, or block driver 230) before being written as encrypted file 242 by block driver 230 to object storage 240.

Devices that support a file system are generally known as block devices, and drivers written for these devices are generally known as block device drivers or block drivers. Block driver 230 may, for example, take a file system request (e.g., in the form of a buf (9S) structure), and issue one or more corresponding I/O operations to the disk to transfer the specified block. Object storage 240 may, for example, be implemented via a block device comprising one or more disks for storing blocks of data.

Certain techniques described herein, such as with respect to FIG. 2, utilize existing types of file system components, such as a mini-filter driver, to implement cryptographic agility for file systems that do not natively support such functionality, without requiring changes to the underlying file system or associated applications.

FIG. 3 is an illustration 300 of another example related to cryptographic agility for data storage. In particular, illustration 300 depicts an embodiment involving a blob storage system.

Application 110 sends data 311 for storage (e.g., via a write request) to a blob storage system, such as by directing a request to a blob metadata layer 320.

A blob storage system generally refers to a type of cloud storage system for unstructured data. A “blob,” which may be considered an acronym for “binary large object,” is a mass of data in binary form that does not necessarily conform to any particular file format. Blob storage allows these masses of data to be stored in non-hierarchical storage areas that are generally referred to as data lakes. Blob storage systems are generally built on top of underlying storage systems, such as file systems, and are abstractions of such underlying storage systems.

Blob metadata layer 320 may be an example component of a storage metadata layer 152 of FIG. 1. Blob storage component 330 and/or object storage 340 may be example components of an object storage later 154 of FIG. 1. In one example, object storage 340 is a data lake, blob storage component 330 is a software application that interfaces directly with the data lake (e.g., issuing I/O commands to the data lake) and blob metadata later 320 comprises a software component that receives I/O requests from separate applications and interfaces between such applications and blob storage component 330. The architecture depicted in FIG. 3 is included as an example, and other architectures are possible for a blob storage system. In certain embodiments, blob metadata layer 320, blob storage component 330, object storage 340, agent 350, and/or generic cryptography module 118 may be located on one or more cloud servers connected via a network to application 110.

Agent 350 intercepts the write request, receiving data 311. Agent 350 may be an example of interception component 160 of FIG. 1. For example, agent 350 may be a software component that is configured to intercept I/O requests directed to blob metadata layer 320 and serve as an interface to generic cryptography module 118 for enabling cryptographic agility for the blob storage system.

Agent 350 sends a cryptographic request 352 to generic cryptography module 118, such as via an API as discussed above with respect to FIG. 1. Cryptographic request 352 may comprise a request to encrypt data 311 for storage. Generic cryptography module 118 receives cryptographic request 352 and dynamically selects one or more cryptographic techniques for handling cryptographic request 352, such as for encrypting data 311. As discussed above with respect to FIG. 1, generic cryptography module 118 may determine attributes related to data 311, such as based on metadata associated with data 211, and select a cryptographic technique based on such attributes, such as according to one or more policies. The attributes may include, in some embodiments, organizational context and/or user context. The attributes may include, in some embodiments, organizational context and/or user context. For example, the attributes may include or be based on a size of data 311, an extension of data 311, an application or user associated with creation or modification of data 311, a name of data 311, contents of data 311, and/or the like.

Generic cryptography module 118 provides cryptographic response 354 to agent 350 in response to cryptographic request 352. Cryptographic response 354 may, for example, comprise an encrypted version of data 311 according to one or more selected cryptographic techniques. For instance, generic cryptography module 118 may encrypt data 311 using a dynamically selected technique and then provide the encrypted data to agent 350. In other embodiments, cryptographic response 354 includes information that can be used by one or more other components to encrypt file 311, such as an indication of a cryptographic technique, an encryption key, and/or the like.

If cryptographic response 354 comprises an encrypted version of data 311, then agent 350 may provide the encrypted data to blob metadata layer 320, which may then provide the encrypted data to blob storage component 330 for writing to object storage 340 as encrypted blob 342. If cryptographic response 354 includes information for use in encrypting data 311, then data 311 may be encrypted by some other component (e.g., associated with agent 350, blob metadata layer 320, or blob storage component 330) before being written as encrypted blob 342 by blob storage component 330 to object storage 340.

In certain embodiments, techniques described herein may be utilized in the context of cloud storage, such as for cloud storage systems that employ blob storage or other types of storage systems. It is noted that techniques described herein are not limited to any particular type or architecture of storage system, and file systems and blob storage systems are included as examples.

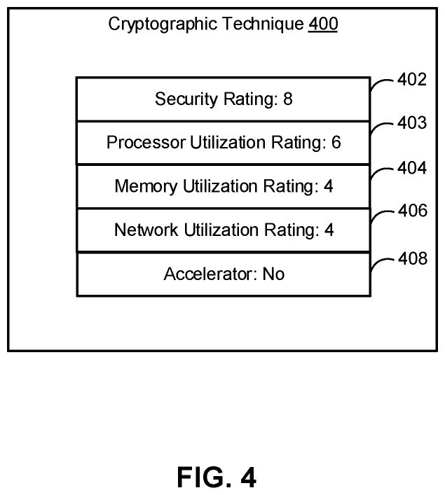

FIG. 4 depicts an example of tagging cryptographic techniques based on attributes, according to embodiments described herein.

A cryptographic technique 400 comprises one or more cryptographic algorithms and/or configurations of algorithms. For instance cryptographic technique 400 may be included in a cryptographic library, and may be registered with library manager 140 of FIG. 1 as an available cryptographic technique for use in a cryptographic agility system.

Tags 402, 403, 404, 406, and 408 are associated with cryptographic technique 400 to indicate characteristics of cryptographic technique 400. For example, these tags may be added by an administrator at the time cryptographic technique 400 is registered with library manager 140 of FIG. 1. While not depicted, cryptographic technique 400 may also be associated with other tags related to, for example, threats protected against by cryptographic technique 400, whether cryptographic technique 400 is quantum-safe, whether cryptographic technique 400 is homomorphic, and/or the like.

Tags 402, 403, 404, 406, and 408 may be based on a variety of characteristics of cryptographic technique 400, such as the nature of involved cryptographic algorithm(s), key size, size of lattice, which elliptic curve is utilized, number of bits of security, whether accelerators are used, ciphertext size, whether side channel attacks are protected against (e.g., resulting in higher resource usage), and/or the like.

Tag 402 indicates that cryptographic technique 400 has a security rating of 8. It is noted that a numerical security rating in a particular range (e.g., 1-10) is included as an example, and other techniques for indicating a level of security may be used.

Tag 403 indicates a processor utilization rating of 6. In an example, processor utilization ratings may range from 0-10, and generally indicate an amount of processing resources required by a cryptographic technique.

Tag 404 indicates a memory utilization rating of 4. In an example, memory utilization ratings may range from 0-10, and generally indicate an amount of memory resources required by a cryptographic technique.

Tag 406 indicates a network utilization rating of 4. In an example, network utilization ratings may range from 0-10, and generally indicate an amount of network resources required by a cryptographic technique.

Tag 408 indicates that an accelerator is not used by cryptographic technique 300.

Tags 402, 403, 404, 406, and 408 are included as examples, and other types of tags may be included. Tags 402, 403, 404, 406, and 408 generally allow a cryptographic agility system to identify which cryptographic techniques are best suited for a given cryptographic request or requests, such as related to a storage request, based on various characteristics.

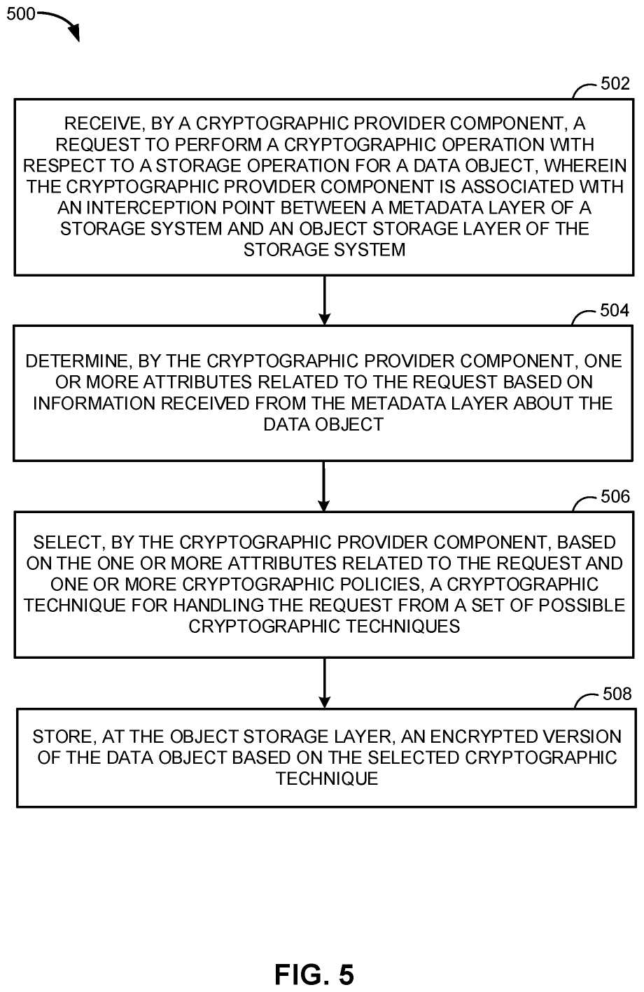

FIG. 5 depicts example operations 500 related to cryptographic agility for data storage according to embodiments of the present disclosure. For example, operations 500 may be performed by one or more components of the cryptographic agility system described above with respect to FIGS. 1-4.

Operations 500 begin at step 502, with receiving, by a cryptographic provider component, a request to perform a cryptographic operation with respect to a storage operation for a data object, wherein the cryptographic provider component is associated with an interception point between a metadata layer of a storage system and an object storage layer of the storage system.

Operations 500 continue at step 504, with determining, by the cryptographic provider component, one or more attributes related to the request based on information received from the metadata layer about the data object. In certain embodiments, the one or more attributes related to the request comprise one or more attributes related to an application, user, or device associated with the request. In some embodiments, the one or more attributes related to the request comprise one or more attributes from a file header associated with the data object.

In certain embodiments, determining the one or more attributes related to the request further comprises using a machine learning model to predict at least one attribute of the one or more attributes related to the request based on features of the data object. For example, the features of the data object may comprise one or more of: a size of the data object; a file extension of the data object; an application or user associated with creation or modification of the data object; a name of the data object; or contents of the data object.

Operations 500 continue at step 506, with selecting, by the cryptographic provider component, based on the one or more attributes related to the request and one or more cryptographic policies, a cryptographic technique for handling the request from a set of possible cryptographic techniques. In some embodiments, the set of possible cryptographic techniques comprises one or more cryptographic techniques that were registered with the cryptographic provider component and that are associated with tags indicating characteristics of the one or more cryptographic techniques.

In certain embodiments, the selecting of the cryptographic technique comprises: determining a required security level based on the one or more attributes related to the request; and determining that the cryptographic technique corresponds to the required security level.

Operations 500 continue at step 508, with storing, at the object storage layer, an encrypted version of the data object based on the selected cryptographic technique.

In some embodiments, the storage system comprises a file system, the data object comprises a file, and the interception point between the metadata layer of the storage system and the object storage layer of the storage system comprises a mini-filter driver. For example, the mini-filter driver is configured to intercept calls to a file system driver of the file system.

In certain embodiments, the storage system comprises a blob storage system, the data object comprises a blob, and the interception point between the metadata layer of the storage system and the object storage layer of the storage system comprises an agent.

The various embodiments described herein may employ various computer-implemented operations involving data stored in computer systems. For example, these operations may require physical manipulation of physical quantities-usually, though not necessarily, these quantities may take the form of electrical or magnetic signals, where they or representations of them are capable of being stored, transferred, combined, compared, or otherwise manipulated. Further, such manipulations are often referred to in terms, such as producing, identifying, determining, or comparing. Any operations described herein that form part of one or more embodiments of the invention may be useful machine operations. In addition, one or more embodiments of the invention also relate to a device or an apparatus for performing these operations. The apparatus may be specially constructed for specific required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and the like.

One or more embodiments of the present invention may be implemented as one or more computer programs or as one or more computer program modules embodied in one or more computer readable media. The term computer readable medium refers to any data storage device that can store data which can thereafter be input to a computer system-computer readable media may be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), a CD (Compact Discs)—CD-ROM, a CD-R, or a CD-RW, a DVD (Digital Versatile Disc), a magnetic tape, and other optical and non-optical data storage devices. The computer readable medium can also be distributed over a network coupled computer system so that the computer readable code is stored and executed in a distributed fashion.

Although one or more embodiments of the present invention have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein, but may be modified within the scope and equivalents of the claims. In the claims, elements and/or steps do not imply any particular order of operation, unless explicitly stated in the claims.

Virtualization systems in accordance with the various embodiments may be implemented as hosted embodiments, non-hosted embodiments or as embodiments that tend to blur distinctions between the two, are all envisioned. Furthermore, various virtualization operations may be wholly or partially implemented in hardware. For example, a hardware implementation may employ a look-up table for modification of storage access requests to secure non-disk data.

Certain embodiments as described above involve a hardware abstraction layer on top of a host computer. The hardware abstraction layer allows multiple contexts to share the hardware resource. In one embodiment, these contexts are isolated from each other, each having at least a user application running therein. The hardware abstraction layer thus provides benefits of resource isolation and allocation among the contexts. In the foregoing embodiments, virtual machines are used as an example for the contexts and hypervisors as an example for the hardware abstraction layer. As described above, each virtual machine includes a guest operating system in which at least one application runs. It should be noted that these embodiments may also apply to other examples of contexts, such as containers not including a guest operating system, referred to herein as “OS-less containers” (see, e.g., www.docker.com). OS-less containers implement operating system-level virtualization, wherein an abstraction layer is provided on top of the kernel of an operating system on a host computer. The abstraction layer supports multiple OS-less containers each including an application and its dependencies. Each OS-less container runs as an isolated process in userspace on the host operating system and shares the kernel with other containers. The OS-less container relies on the kernel's functionality to make use of resource isolation (CPU, memory, block I/O, network, etc.) and separate namespaces and to completely isolate the application's view of the operating environments. By using OS-less containers, resources can be isolated, services restricted, and processes provisioned to have a private view of the operating system with their own process ID space, file system structure, and network interfaces. Multiple containers can share the same kernel, but each container can be constrained to only use a defined amount of resources such as CPU, memory and I/O. The term “virtualized computing instance” as used herein is meant to encompass both VMs and OS-less containers.

Many variations, modifications, additions, and improvements are possible, regardless the degree of virtualization. The virtualization software can therefore include components of a host, console, or guest operating system that performs virtualization functions. Plural instances may be provided for components, operations or structures described herein as a single instance. Boundaries between various components, operations and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claim(s).

We claim:

1. A method of cryptographic agility for data storage, comprising:
receiving, by a cryptographic provider component, a request to perform a cryptographic operation with respect to a storage operation for a data object, wherein the cryptographic provider component is associated with an interception point between a metadata layer of a storage system and an object storage layer of the storage system;
determining, by the cryptographic provider component, one or more attributes related to the request based on information received from the metadata layer about the data object;
selecting, by the cryptographic provider component, based on the one or more attributes related to the request and one or more cryptographic policies, a cryptographic technique for handling the request from a set of possible cryptographic techniques; and
storing, at the object storage layer, an encrypted version of the data object based on the selected cryptographic technique.

2. The method of claim 1, wherein the one or more attributes related to the request comprise one or more attributes from a file header associated with the data object.

3. The method of claim 1, wherein the one or more attributes related to the request comprise one or more attributes related to an application, user, or device associated with the request.

4. The method of claim 1, wherein the set of possible cryptographic techniques comprises one or more cryptographic techniques that were registered with the cryptographic provider component and that are associated with tags indicating characteristics of the one or more cryptographic techniques.

5. The method of claim 1, wherein the selecting of the cryptographic technique comprises:
determining a required security level based on the one or more attributes related to the request; and
determining that the cryptographic technique corresponds to the required security level.

6. The method of claim 1, wherein determining the one or more attributes related to the request further comprises using a machine learning model to predict at least one attribute of the one or more attributes related to the request based on features of the data object.

7. The method of claim 6, wherein the features of the data object comprise one or more of:
a size of the data object;
a file extension of the data object;
an application or user associated with creation or modification of the data object;
a name of the data object; or
contents of the data object.

8. The method of claim 1, wherein:
the storage system comprises a file system;
the data object comprises a file; and
the interception point between the metadata layer of the storage system and the object storage layer of the storage system comprises a mini-filter driver.

9. The method of claim 8, wherein the mini-filter driver is configured to intercept calls to a file system driver of the file system.

10. The method of claim 1, wherein:
the storage system comprises a blob storage system;
the data object comprises a blob; and
the interception point between the metadata layer of the storage system and the object storage layer of the storage system comprises an agent.

11. A system for cryptographic agility for data storage, comprising:
at least one memory; and
at least one processor coupled to the at least one memory, the at least one processor and the at least one memory configured to:
receive, by a cryptographic provider component, a request to perform a cryptographic operation with respect to a storage operation for a data object, wherein the cryptographic provider component is associated with an interception point between a metadata layer of a storage system and an object storage layer of the storage system;
determine, by the cryptographic provider component, one or more attributes related to the request based on information received from the metadata layer about the data object;
select, by the cryptographic provider component, based on the one or more attributes related to the request and one or more cryptographic policies, a cryptographic technique for handling the request from a set of possible cryptographic techniques; and
store, at the object storage layer, an encrypted version of the data object based on the selected cryptographic technique.

12. The system of claim 11, wherein the one or more attributes related to the request comprise one or more attributes from a file header associated with the data object.

13. The system of claim 11, wherein the one or more attributes related to the request comprise one or more attributes related to an application, user, or device associated with the request.

14. The system of claim 11, wherein the set of possible cryptographic techniques comprises one or more cryptographic techniques that were registered with the cryptographic provider component and that are associated with tags indicating characteristics of the one or more cryptographic techniques.

15. The system of claim 11, wherein the selecting of the cryptographic technique comprises:
determining a required security level based on the one or more attributes related to the request; and
determining that the cryptographic technique corresponds to the required security level.

16. The system of claim 11, wherein determining the one or more attributes related to the request further comprises using a machine learning model to predict at least one attribute of the one or more attributes related to the request based on features of the data object.

17. The system of claim 16, wherein the features of the data object comprise one or more of:
a size of the data object;
a file extension of the data object;
an application or user associated with creation or modification of the data object;
a name of the data object; or
contents of the data object.

18. The system of claim 11, wherein:
the storage system comprises a file system;
the data object comprises a file; and
the interception point between the metadata layer of the storage system and the object storage layer of the storage system comprises a mini-filter driver.

19. The system of claim 18, wherein the mini-filter driver is configured to intercept calls to a file system driver of the file system.

20. A non-transitory computer readable medium storing instructions that, when executed by one or more processors, cause the one or more processors to:
receive, by a cryptographic provider component, a request to perform a cryptographic operation with respect to a storage operation for a data object, wherein the cryptographic provider component is associated with an interception point between a metadata layer of a storage system and an object storage layer of the storage system;
determine, by the cryptographic provider component, one or more attributes related to the request based on information received from the metadata layer about the data object;
select, by the cryptographic provider component, based on the one or more attributes related to the request and one or more cryptographic policies, a cryptographic technique for handling the request from a set of possible cryptographic techniques; and
store, at the object storage layer, an encrypted version of the data object based on the selected cryptographic technique.
